(19) United States
(12) Patent Application Publication
(10) Pub. No.: US 2014/0161391 A1
(43) Pub. Date: Jun. 12, 2014

(54) OPTICAL MODULE AND OPTICAL TRANSMISSION METHOD

(71) Applicant: Mitsubishi Electric Corporation, Chiyoda-ku (JP)

(72) Inventors: Nobuo OHATA, Chiyoda-ku (JP); Kyosuke KURAMOTO, Chiyoda-ku (JP); Hiroshi ARUGA, Chiyoda-ku (JP)

(73) Assignee: Mitsubishi Electric Corporation, Chiyoda-ku (JP)

(21) Appl. No.: 13/963,268

(22) Filed: Aug. 9, 2013

(30) Foreign Application Priority Data
Dec. 6, 2012 (JP) 2012-267143
Mar. 14, 2013 (JP) 2013-051615

(51) Int. Cl. G02B 6/32

(52) U.S. Cl. CPC G02B 6/32
USPC 385/33

(57) ABSTRACT

To provide an optical module and optical transmission method that reduce tracking errors caused by position shifting of the focal point of light related to the optical axis direction, using a simpler method. A lens 1 causes light emitted from an emission point to be focused at a focal point. A lens cap 2 is provided on a stem 6 and supports the lens 1. A semiconductor laser 3 is provided on the stem 6 and emits light from a position corresponding to the emission point. A control member 7 controls position shifting of the focal point generated by thermal expansion of the lens cap 2, through thermal expansion in the direction of the optical axis of the lens 1.

### CROSS-REFERENCE TO RELATED APPLICATION

This application claims the benefit of Japanese Patent Application No. 2012-267143, filed on Dec. 6, 2012, and Japanese Patent Application No. 2013-51615, filed on Mar. 14, 2013, the disclosures of which are incorporated by reference herein.

### FIELD

This application relates generally to an optical module and an optical transmission method.

### BACKGROUND

Accompanying the increase in communication volume on the Internet in recent years, optical modules capable of transmitting high-speed optical signals have been sought even in optical access systems. The speed of the high-speed optical signals demanded is, for example, on the order of 10 Gbps.

In such an optical module, simultaneous with increases in signal transmission speed, cost reduction is also demanded. Hence, of late the tendency has been to use a package known as TO-CAN (Transistor Outlined CAN) type, which is cheaper than the BOX-type package used conventionally. Below, this package will be called a TO-CAN-type package.

A TO-CAN-type package has the shape of a can. With a TO-CAN-type package, a semiconductor laser and/or the like is sealed inside the package by a lens cap that is integrated with a lens or light ejection window being low-resistance welded to a stem. Light emitted from this semiconductor laser is focused via the lens fixed to the lens cap and is incident on the input end of an optical fiber. Because manufacturing with press processing is possible if this is a TO-CAN-type package, reduction of manufacturing costs is expected.

With a TO-CAN-type package, the semiconductor laser and/or the like generates heat. In addition, the TO-CAN-type package is affected by environmental temperature changes. To prevent property changes due to temperature fluctuations in the semiconductor laser caused by this, with the TO-CAN-type package a Peltier device for keeping the temperature of surrounding materials constant is positioned on top of the stem. On this Peltier device, a semiconductor laser, a monitoring photodiode for monitoring output from the semiconductor laser, a thermistor and/or the like are provided as surrounding materials. These surrounding materials are arranged on the Peltier device, so thermal expansion is reduced. Consequently, the amount of fluctuation in the position of the semiconductor laser using the stem as a base is also reduced.

However, the Peltier device does not cool as far as the lens cap. Consequently, the lens cap thermally expands due to environmental temperature changes and heat generated within the TO-CAN-type package. Due to this thermal expansion, the position of the lens fixed to the lens cap fluctuates, with the stem as the standard. Because of the above, the distance between the semiconductor laser and the lens fluctuates because of heat generated within the TO-CAN-type package. Due to these fluctuations, the focal point of light via the lens shifts from the incident end of the optical fiber so that the light coupling efficiency to the optical fiber declines. When the light coupling efficiency declines, tracking errors caused by fluctuations in the light output from the optical fiber occur.

Hence, a TO-CAN-type package has been disclosed in which a separate lens is disposed between the lens and the semiconductor laser emitter on the Peltier device (for example, see Patent Literature 1). This TO-CAN-type package reduces tracking errors by making light emitted from the semiconductor laser emitter become collimated light using the lens positioned between the semiconductor laser emitter and the lens.

In addition, a light transmission module has been disclosed in which a member having prescribed refractive-index temperature-change properties is disposed between the lens and the optical fiber (for example, see Patent Literature 2). Position shifts in a direction orthogonal to the optical axis of the lens arise due to differences in thermal expansion coefficients between the semiconductor laser and the lens between the core center in the incident end of the optical fiber and the focal point of light via the lens. This optical transmission module reduces position shifts using this member.
Patent Literature 1: Unexamined Japanese Patent Application Kokai Publication No. 2011-108937.
Patent Literature 2: Unexamined Japanese Patent Application Kokai Publication No. 2003-248144.

### SUMMARY

However, the TO-CAN-type package disclosed in the aforementioned Patent Literature 1 requires an additional lens. In addition to the increase in cost as a result of the lens addition, it is necessary for the lens to be accurately positioned in order to generate collimated light. This does not satisfy the need for lower costs and invites enlargement of the package. In addition, the optical transmission module disclosed in Patent Literature 2 cannot reduce tracking errors caused by position shifts related to the optical axis direction at the focal point of light passing through the lens.

In consideration of the foregoing, it is an objective of the present invention to provide an optical module and optical transmission method capable of reducing tracking errors caused by position shifts in the focal point of light related to the optical axis direction using a more convenient method.

To achieve the above objective, an optical module according to the present invention comprises an optical device, a support body and a control member. The optical device focuses at a focal point light emitted from an emission point. The support body is provided on a substrate and supports the optical device. The control member controls position shifting of the focal point generated by thermal expansion of the support body, through thermal expansion in the direction of the optical axis of the optical device.

With the present invention, tracking errors caused by position shifts in the focal point of light related to the optical axis direction are reduced using a more convenient method.

### BRIEF DESCRIPTION OF THE DRAWINGS

A more complete understanding of this application can be obtained when the following detailed description is considered in conjunction with the following drawings, in which:

FIG. 1 is a drawing showing the composition of an optical module according to a first preferred embodiment of the present invention;

FIGS. 2A to 2C are drawings explaining position shifts in the focal point and a distance reduction between the focal points, with FIG. 2A showing the state of an optical module in which there is no control member at a temperature of 25° C., FIG. 2B showing the state of an optical module in which there is no control member at a temperature of 80° C., and FIG. 2C showing the state of the optical module shown in FIG. 1 at a temperature of 80° C.;

FIG. 3 is a drawing explaining the relationship between position shifts in the focal point and changes in the thickness of a transmissive member in the optical module according to a first preferred embodiment of the present invention;

FIG. 4 is a drawing showing the relationship between the temperature of the optical module and the light coupling efficiency to the optical fiber;

FIG. 5 is a drawing showing one example of the shape of a transmissive member that has rotational symmetry about the optical axis;

FIG. 6 is a drawing showing a result of thermal stress analysis on the optical module at a temperature of 90° C.;

FIG. 7 is a drawing showing a result of thermal stress analysis on the optical module at a temperature of −40° C.;

FIG. 8 is a drawing showing one example of the shape of the transmissive member;

FIG. 9 is a drawing showing the composition of an optical module according to a second preferred embodiment of the present invention;

FIG. 10 is a drawing explaining the relationship between position shifts in the focal point and changes in the thickness of a transmissive member in the optical module according to the second preferred embodiment of the present invention;

FIG. 11 is a drawing showing the composition of an optical module according to a third preferred embodiment of the present invention; and

FIG. 12 is a drawing showing the composition of an optical module according to a fourth preferred embodiment of the present invention.

### DETAILED DESCRIPTION

The preferred embodiments according to the present invention are described below with reference to the attached drawings. The present invention is not limited by the below-described preferred embodiments or drawings.

### First Preferred Embodiment

First, a first preferred embodiment of the present invention is described.

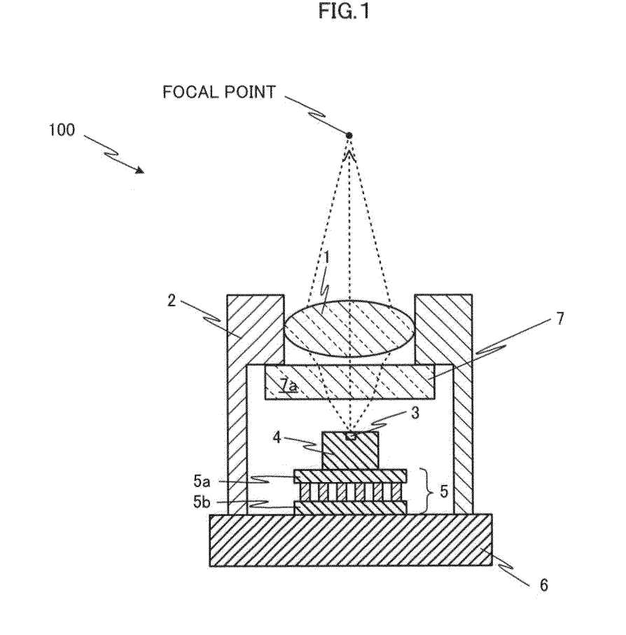

FIG. 1 shows the composition of an optical module 100 according to a first preferred embodiment. Below, a detailed description is given centered on the optical system of the optical module 100 with a TO-CAN-type for optical transmission used as an example, with reference to FIG. 1. The optical module 100 comprises a lens 1, a lens cap 2, a semiconductor laser 3, a carrier 4, a Peltier device 5, a stem 6 and a control member 7.

The lens 1 (optical device) is a convex lens for focusing at a focal point light emitted from an emission point. The semiconductor laser 3 disposed on the stem 6 is installed at the position corresponding to the emission point. An input end and/or the like of an optical fiber connected to the optical module 100, for example, is positioned at the position corresponding to the focal point.

The lens cap 2 is a conically shaped member. The lens cap 2 is installed on the stem 6. The lens cap 2 supports the lens 1. More specifically, the lens cap 2 is formed so as to support the lens 1 on the top edge of the lens cap 2. The bottom edge of the lens cap 2 is attached to the stem 6. The lens cap 2 is formed of a metal material such as stainless steel (SUS).

The semiconductor laser 3 is installed on the stem 6 via the carrier 4 and the Peltier device 5. The semiconductor laser 3 emits light toward the lens 1. Of necessity, the position of the semiconductor laser 3 determines the position corresponding to the emission point. Light emitted from the semiconductor laser 3 is focused at the focal point shown in FIG. 1 via the lens 1 supported by the lens cap 2.

The semiconductor laser 3 loaded on a submount of aluminum and/or the like is mounted in the carrier 4. In the optical module 100, the properties of the semiconductor laser 3 change greatly accompanying generation of heat by the semiconductor laser 3 and also changes in the environmental temperature of the optical module 100. In order to keep changes in the properties of the semiconductor laser 3 caused by temperatures changes within a prescribed range, the carrier 4 is in contact with and positioned on the top surface of the Peltier device 5 that acts as an electronic cooling device. The carrier 4 is, for example, made of metal such as metal compounds of copper and tungsten.

The Peltier device 5 is provided with a top layer 5a the surface of which is a temperature-regulating surface, and a bottom layer 5b the surface of which is a heat-sink surface. On the top layer 5a, a thermistor and/or the like is connected. The temperature of the top layer 5a is controlled to a constant based on the temperature of the top layer 5a measured by the thermistor. In this manner, the Peltier device 5 regulates the temperature of the carrier 4 positioned on the top surface thereof. Doing this ensures that no thermal expansion of the parts surrounding the semiconductor laser 3 occurs because the temperature of the carrier 4 and the semiconductor laser 3 is kept at a constant. The bottom layer 5b is in contact with the stem 6, so it is possible to efficiently let heat generated during operation of the semiconductor laser 3 escape via the stem 6.

The above-described parts are mounted on the stem 6 as basic members. The stem 6 is preferably formed of cold-rolled steel and/or the like having a high heat transfer ratio in order to let heat generated during operation of the optical module 100 escape efficiently.

On the other hand, the lens cap 2 is attached to the stem 6 independently of the Peltier device 5 whose temperature is controlled and thus thermally expands and contracts due to changes in the environmental temperature and heat generated during operation of the optical module 100. Consequently, the position of the lens 1 moves relative to the position of the semiconductor laser 3. Because the relative distance between the semiconductor laser 3 and the lens 1 changes, that is to say the distance between the emission point (object point) and the principal point of the lens 1 changes, conversely the distance between the principal point and the focal point (imaging point) changes and the focal point becomes shifted.

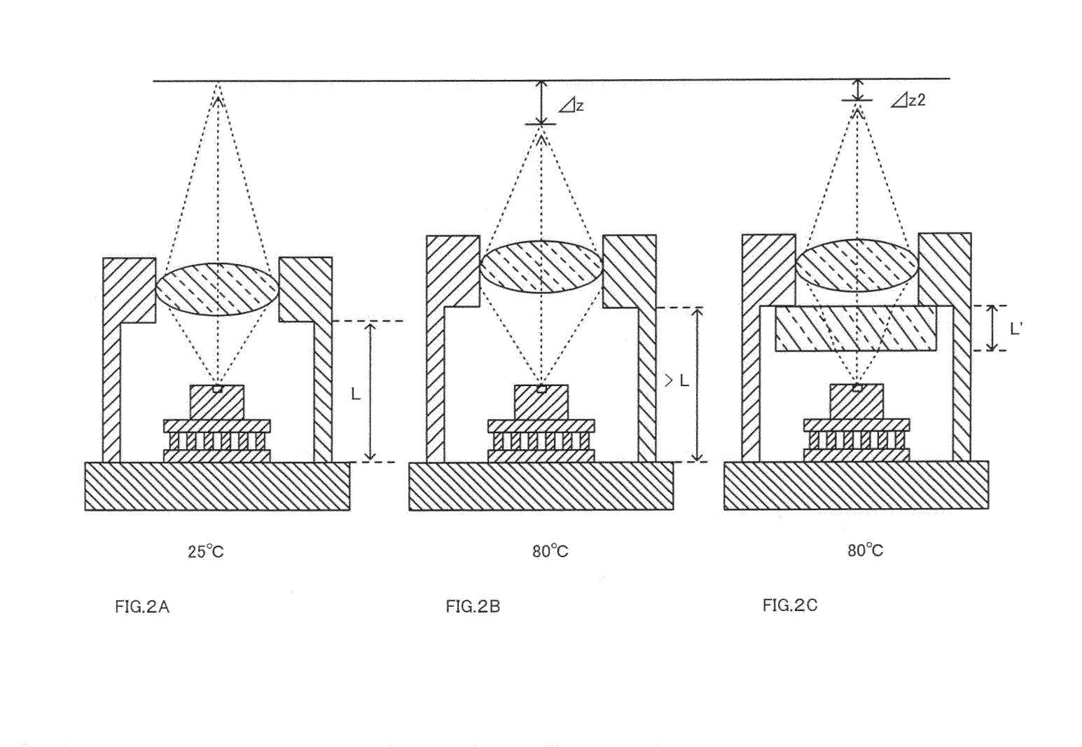

Next, control of thermal expansion of the lens cap 2 and position shifting of the focal point is explained with reference to FIGS. 2A to 2C. FIG. 2A shows the optical module 100 on which the control member 7 is not mounted. When the semiconductor laser 3 does not emit light, the temperature of the optical module 100 is for example 25° C. When the temperature of the optical module 100 is 25° C., the length of the lens cap 2 is L. In this state, the focal point coincides with a prescribed position.

FIG. 2B shows the state when the semiconductor laser 3 of the optical module 100 of FIG. 2A emits light. In this state, the temperature of the optical module 100 becomes, for example, 80° C. due to heat generation during operation. When the temperature of the optical module 100 is 80° C., the length of the lens cap 2 is longer than L due to thermal expansion.

When the change in temperature is ΔT, the linear thermal expansion coefficient of the lens cap 2 is α and the optical magnification of the lens 1 is M, the position shift Δz of the focal point is expressed by the following equation:

Δz=ΔT·α·L·M²

For example, the linear thermal expansion coefficient α of the lens cap 2 is 1×10⁻⁵/K. The optical magnification M of the lens 1 is 3-5.

Returning to FIG. 1, the control member 7 controls position shifting of the focal point caused by thermal expansion of the lens cap 2 through thermal expansion of the lens 1 in the optical axis direction. For example, the control member 7 is a transmissive member 7a set on the optical axis between the emission point and the focal point. Below, the control member 7 is also called the transmissive member 7a.

In the example of FIG. 1, the transmissive member 7a is made to contact the lens cap 2 and is set on the optical axis between the lens 1 and the semiconductor laser 3 positioned at a position corresponding to the emission point. The shape of the transmissive member 7a is a parallel slab, for example.

Here, control of the position shifting of the focal point by the transmissive member 7a is explained. FIG. 2C shows the state during operation of the optical module 100 according to this preferred embodiment. The thickness of the transmissive member 7a is L′. When the refractivity of the transmissive member 7a is taken to be n and the linear thermal expansion coefficient of the transmissive member 7a is taken to be α′, the position shift Δz2 of the focal point in FIG. 2C is expressed by the following equation:

Δz2=ΔT·(α·L−α′(1−1/n)L′)·M²

Because the transmissive member 7a is in contact with the lens cap 2, the thickness L′ of the transmissive member 7a increases in the optical axis direction of the lens 1 due to thermal expansion in accordance with temperature increases in the lens cap 2. According to the above-described equation expressing Δz2, the position shift of the focal point declines due to the thickness L′ of the transmissive member 7a increasing.

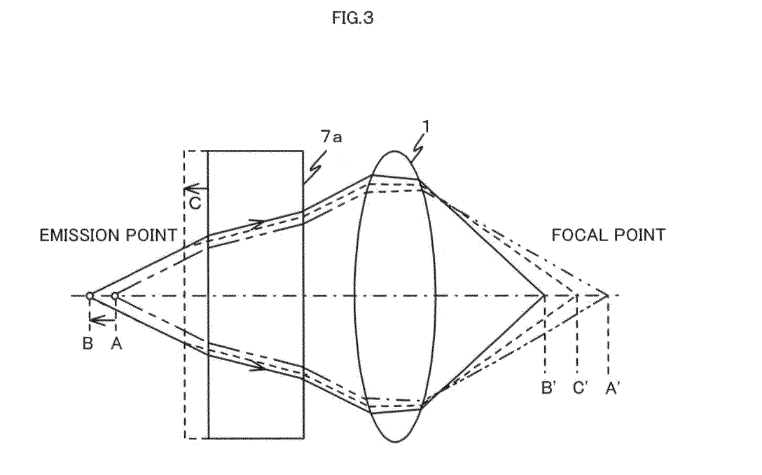

FIG. 3 shows the relationship between changes in the thickness of the transmissive member 7a and the position shifting of the focal point. A point A is the emission point of light when the lens cap 2 has not yet thermally expanded. In this case, light that has passed through the lens 1 is focused at a point A′ along the optical route indicated by the double-broken line. Now suppose the lens cap 2 expands and the emission point of light shifts from the point A to a point B with respect to the lens 1. In this case, assuming the transmissive member 7a did not expand, following imaging equations the light that has passed through the lens 1 is focused at a point B′ along the optical path indicated by the solid line. In reality, however, due to the expansion (C) of the transmissive member 7a, the light is focused on a point C′ along the optical path indicated by the broken line. In this manner, position shifting of the focal point from the point B′ to the point C′ is controlled by expansion of the transmissive member 7a.

The refractivity n of the transmissive member 7a preferably exceeds the refractivity of the atmosphere (here, air). By having the refractivity n that exceeds the refractivity of the atmosphere, light incident on the transmissive member 7a is refracted and the air conversion length of the optical path from the emission point of the light to the lens 1 becomes shorter. As a result, Δz2 becomes smaller. The air conversion length is the length of the optical path in the optical system converted to the length of the optical path in the air, whose refractivity is 1. For example, when the light is passing through a medium of refractivity n, the air conversion length of the optical path of that light is found by multiplying the length of that optical path by 1/n. When the inside of the lens cap 2 is filled with air, the larger the refractivity of the transmissive member 7a beyond the refractivity 1 of the air, the better. The transmissive member 7a is made of a polycarbonate (PC) resin plastic and/or the like. Expansion of the transmissive member 7a further shortens the air conversion length of the light path to the lens 1 from the emission point of the light, so that ultimately position shifting of the focal point is controlled.

The linear thermal expansion coefficient of the transmissive member 7a is preferably greater than 1/(1−1/n) times the linear thermal expansion coefficient of the lens cap 2. The linear thermal expansion coefficient α′ of the PC resin plastic is around 6×10⁻⁵/K. The linear thermal expansion coefficient of the PC resin plastic is more than three times that of the SUS or other metal used in the lens cap 2. In addition, PC resin plastic is transparent, has little absorption of laser light with a wavelength of 1550 nm, for example, and is ideal for the transmissive member 7a. The transmissive member 7a may also have its surface covered with an anti-reflection (AR) coating.

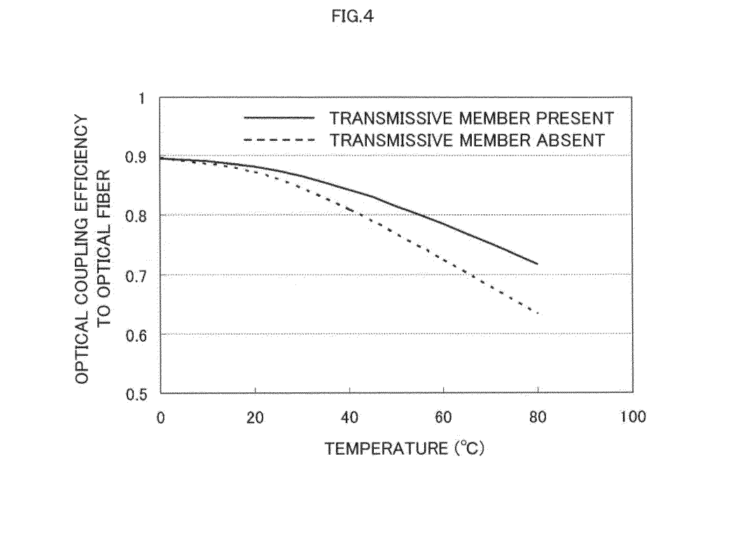

FIG. 4 shows the calculation results of the light coupling efficiency property to the optical fiber positioned at the focal point with respect to the temperature of the optical module 100. In calculating the light coupling efficiency, the linear thermal expansion coefficient α′ of the transmissive member 7a was taken to be 6×10⁻⁵/K and the refractivity was taken to be 1.5. In addition, in this calculation absorption of light by the transmissive member 7a was assumed to be virtually nonexistent. In addition, Fresnel reflection by the transmissive member 7a can be ignored by implementing an AR coating on the surface of the transmissive member 7a.

When there is no transmissive member 7a (see FIG. 2B), the light coupling efficiency declines as the temperature rises. In contrast, when there is a transmissive member (see FIG. 2C), the decline in the light coupling efficiency accompanying rising temperatures is curtailed compared to the case with no transmissive member 7a.

As described in detail above, with the optical module 100 according to this preferred embodiment, the transmissive member 7a thermally expands in the direction of the optical axis of the lens 1 in accordance with the rising temperature of the lens cap 2. Consequently, position shifting of the focal point generated by thermal expansion of the lens cap 2 is controlled. By doing this, it is possible to reduce tracking errors caused by position shifting of the focal point of light related to the direction of the optical axis through a simpler method.

In addition, with this preferred embodiment, the transmissive member 7a is positioned between the focal point of the light and the lens 1. By doing this, the transmissive member 7a is housed inside the lens cap 2, so it is possible to curtail increases in the size of the optical module 100.

In addition, in this preferred embodiment the shape of the transmissive member 7a was taken to be a parallel slab. By doing this, it is easy to process the transmissive member 7a, which is advantageous in terms of production costs. The shape of the transmissive member 7a may be that of a lens. By doing this, it is possible for the transmissive member 7a to broaden the adjustment range of the optical magnification of the optical module 100.

In this preferred embodiment, the transmissive member 7a may be made of plastic. Plastic is relatively inexpensive and can help control production costs for the optical module 100. In particular, PC resin plastic is ideal, being transmissive, shock-resistant, heat-resistant and flame-resistant.

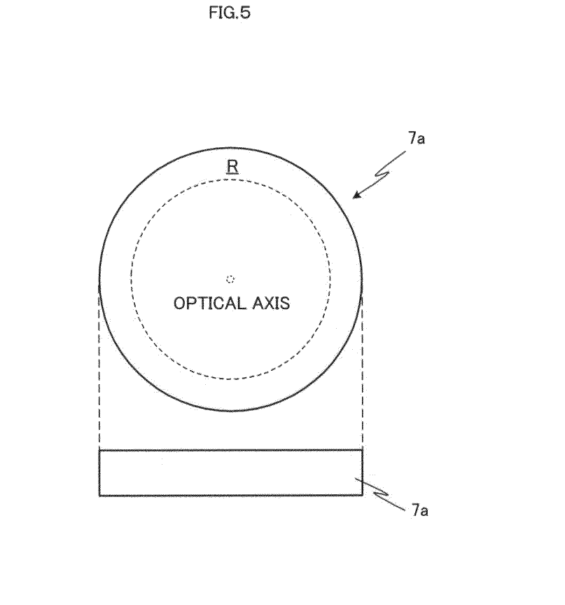

In addition, the transmissive member 7a may have various shapes other than a parallel slab or a lens. The shape of the transmissive member 7a preferably has rotational symmetry about the optical axis. For example, the shape of the transmissive member 7a may be a cylinder with the optical axis as the center axis. FIG. 5 shows a top view and side view of a transmissive member 7a having a cylindrical shape attached to a lens cap 2. On the top surface of the transmissive member 7a, a fringe R is provided on the outside of the broken line with the axis of rotation as a standard. The transmissive member 7a is fixed to the lens cap 2 by the fringe R on the top surface attached to the lens cap 2. The fringe R and the lens cap 2 are fixed by means of an adhesive agent and/or the like. In this case, an adhesive agent is uniformly coated on the fringe R and the transmissive member 7a is preferably positioned so that the optical axis of the lens 1 and the optical axis (rotational symmetry axis) of the transmissive member 7a match.

By using a transmissive member 7a whose linear thermal expansion coefficient α′ is greater than the linear thermal expansion coefficient of the lens cap 2, the transmissive member 7a positioned as described above is restricted by the lens cap 2 having a smaller linear thermal expansion coefficient than the linear thermal expansion coefficient α′ of the member itself. As a result, accompanying changes in the environmental temperature of the optical module 100, the transmissive member 7a receives larger thermal stress on the parts separated from the rotational symmetry axis and warps about the optical axis.

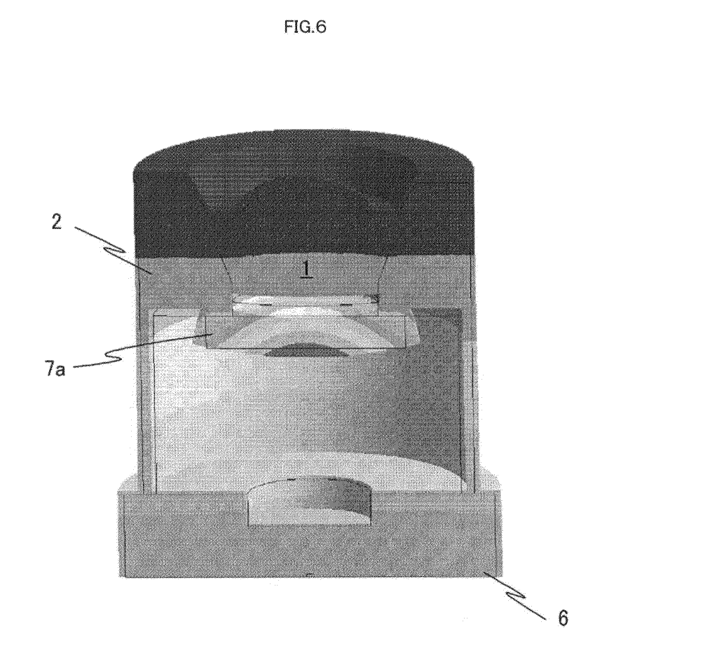

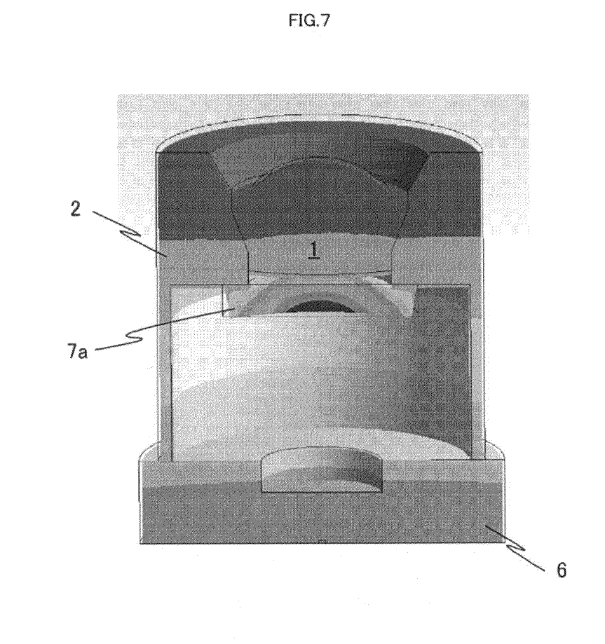

That is to say, the transmissive member 7a deforms to a convex shape or a concave shape in the direction of the optical axis of the semiconductor laser 3 in accordance with changes in temperature. FIGS. 6 and 7 show the results of thermal stress analysis on the optical module 100. FIGS. 6 and 7 are the composition used for thermal stress analysis so the semiconductor laser 3, the carrier 4 and the Peltier device 5 are not shown. At an environmental temperature of 25° C., the top surface of the transmissive member 7a on the lens 1 side and the bottom surface of the transmissive member 7a on the stem 6 side are parallel. When the environmental temperature is 90° C., the radius of curvature of the transmissive member 7a becomes 850 mm, and the shape of the transmissive member 7a becomes a convex shape toward the stem 6 side as shown in FIG. 6. On the other hand, when the environmental temperature is −40° C., the radius of curvature of the transmissive member 7a becomes 600 mm, and the shape of the transmissive member 7a becomes concave to the lens 1 side as shown in FIG. 7.

The transmissive member 7a has a linear thermal expansion coefficient α′ that is greater than the linear thermal expansion coefficient of the lens cap 2, is positioned so that the rotational symmetry axis of the transmissive member and the optical axis of the lens 1 match, and is fixed to the lens cap 2 at the fringe R. By doing this, when the environmental temperature changes the transmissive member 7a warps about a point on the optical axis, and it is possible to make the position of the focal point of the light change in the direction of the optical axis of the lens 1 using the lens action of the transmissive member 7a. By adjusting the distance between the semiconductor laser 3 and the transmissive member 7a and the distance between the transmissive member 7a and the lens 1 in accordance with the properties of the transmissive member 7a, it is possible to cause this lens action to effectively contribute to correction of position shifting of the focal point generated by thermal expansion of the lens cap 2.

By shifting the optical axis of the lens 1 and the optical axis (rotational symmetry axis) of the transmissive member 7a, it is possible to cause the focal point of the lens 1 to shift in a direction orthogonal to the direction of the optical axis of the lens 1 in accordance with an imaging formula. Consequently, it is possible to reduce tracking errors caused by position shifting of the focal point of light relating to a direction orthogonal to the direction of the optical axis, in addition to tracking errors caused by positioning shifting of the focal point of the light related to the optical axis direction.

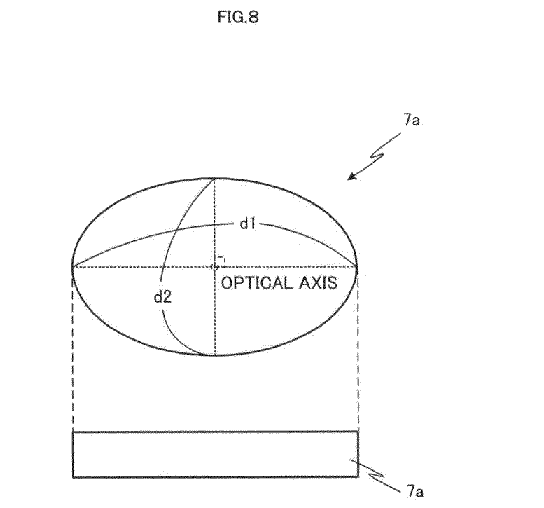

In addition, it is fine for the shape of the transmissive member 7a to be such that the length in a first direction orthogonal to the optical axis direction and the length in a second direction orthogonal to the optical axis and the first direction differ. For example, as shown in FIG. 8, if the transmissive member 7a has a cylindrical shape with the cross section being an ellipse, the shape of the transmissive member 7a is such that the length d2 of a second direction orthogonal to a first direction and the optical axis is shorter than the length d1 in the first direction orthogonal to the optical axis direction. By so doing, it is possible to shape light emitted from the semiconductor laser 3 into a beam having a different cross-section, in accordance with temperature changes, and to cause the aspect ratio of the transmissive member 7a to change.

It would be fine for the optical module 100 to be provided with a monitoring photodiode for receiving a portion of the light emitted from the semiconductor laser 3. By doing this, it is possible for the optical module 100 to appropriately control the driving current.

In addition, it would be fine for the optical module 100 to be provided with a high-frequency substrate from which good electric properties are obtainable.

### Second Preferred Embodiment

Next, a second preferred embodiment of the present invention is described.

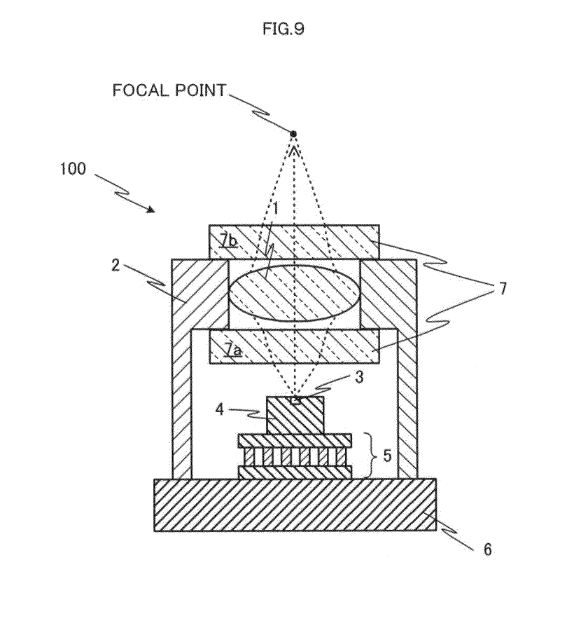

FIG. 9 shows the composition of an optical module 100 according to this preferred embodiment. The optical module 100 according to this preferred embodiment differs from the above-described first preferred embodiment in further comprising a transmissive member 7b as a control member 7. The point of difference between the transmissive member 7a and the transmissive member 7b is the position where each is positioned. The transmissive member 7b is positioned between the lens 1 and the focal point. In other words, the transmissive members 7a and 7b are respectively established on both sides of the lens 1 in the optical axis direction.

The transmissive member 7b is made of PC resin plastic, for example, the same as the transmissive member 7a. As shown in FIG. 9, the transmissive member 7b is placed in contact with the lens cap 2. Because of this contact with the lens cap 2, the transmissive member 7b thermally expands in the direction of the optical axis of the lens 1 in accordance with the rising temperature of the lens cap 2, and the thickness increases.

Control of the position shifting of the focal point and thermal expansion of the lens cap 2 in this preferred embodiment will now be explained. Due to heat generation by the optical module 100 during operation, the length of the lens cap 2 lengthens in the direction of the focal point of the lens 1. Because of being in contact with the lens cap 2, the transmissive members 7a and 7b thermally expand in the direction of the optical axis of the lens 1 in accordance with the rising temperature of the lens cap 2. As a result, the thicknesses of the transmissive members 7a and 7b increase, so position shifting of the focal point is further controlled.

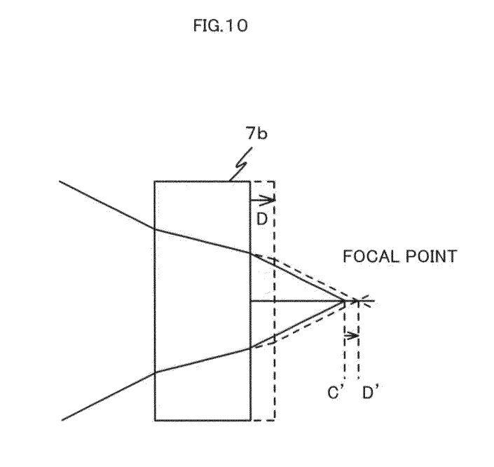

As shown in FIG. 10, when the transmissive member 7b is not expanded, light via the lens 1 follows the optical path indicated by the solid line, and is focused on a point C′, but when the transmissive member 7b expands (D), the light is focused at a point D′. As a result, position shifting of the focal point is further controlled and it is possible to cause the focal point to more closely approach the original point A′.

As described in detail above, with the optical module 100 according to this preferred embodiment, the transmissive members 7a and 7b thermally expand in the direction of the optical axis of the lens 1 in accordance with the rising temperature of the lens cap 2. Consequently, position shifting of the focal point generated by thermal expansion of the lens cap 2 is further controlled. By doing this, it is possible to further reduce tracking errors caused by position shifting of the focal point of light related to the optical axis direction.

In addition, in this preferred embodiment, the transmissive member 7b was positioned between the lens 1 and the focal point. By doing this, the transmissive member 7b is attached on the outside of the lens cap 2, so adjustments such as of the thickness of the transmissive member 7b and maintenance such as exchanging the transmissive member 7b are easy after attaching such to the lens cap 2.

In this preferred embodiment, the explanation was for a composition in which the optical module 100 is provided with a transmissive member 7a but the transmissive member 7a need not be provided. In addition, it would be fine for the transmissive members 7a and 7b to both be lenses. By doing this, it is possible to broaden the adjustment range of the optical magnification of the optical module 100.

### Third Preferred Embodiment

Next, a third preferred embodiment of the present invention is described.

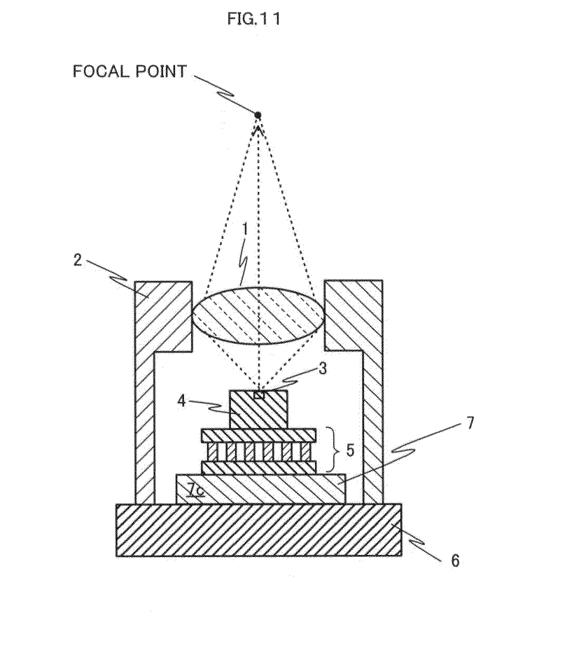

FIG. 11 shows the composition of an optical module 100 according to this preferred embodiment. The optical module 100 according to this preferred embodiment differs from the above-described first preferred embodiment in the position where the control member 7 is provided. Below, the control member 7 is described as a control member 7c.

The control member 7c is inserted between the stem 6 and the semiconductor laser 3. More specifically, the control member 7c is positioned between the bottom surface of the Peltier device 5 and the stem 6. The control member 7c thermally expands in the direction of the optical axis of the lens 1 in accordance with rising temperature of the stem 6, causing the thickness to increase.

Thermal expansion of the lens cap 2 and control of position shifting of the focal point in this preferred embodiment will be explained. The length of the lens cap 2 becomes longer in the direction of the focal point of the lens 1 due to heat generation by the optical module 100. Being in contact with the stem 6, the control member 7c thermally expands in accordance with the rising temperature of the stem 6. As a result, the thickness of the control member 7c increases in the direction of the optical axis of the lens 1.

When the thickness of the control member 7c increases, the semiconductor laser 3 is pushed in the direction of the focal point. As a result, lengthening of the relative distance between the semiconductor laser 3 and the lens 1 due to thermal expansion of the lens cap 2 is controlled, ultimately making it possible to control position shifting of the focal point.

As explained in detail above, the optical module 100 according to this preferred embodiment is provided with a control member 7c that is inserted between the stem 6 and the semiconductor laser 3 and that thermally expands in the direction of the optical axis of the lens 1 in accordance with the rising temperature of the stem 6. Consequently, fluctuations in the distance between the lens 1 and the semiconductor laser 3 due to thermal expansion of the lens cap 2 are controlled. By doing this, it is possible to reduce tracking errors caused by position shifting of the focal point of the light related to the optical axis direction using a simpler method.

It would be fine for the optical module 100 according to this preferred embodiment to also be provided with at least one out of the transmissive member 7a in the above-described first preferred embodiment and the transmissive member 7b in the second preferred embodiment. By doing this, tracking errors caused by position shifting of the focal point of the light related to the optical axis direction are further reduced. At this time, it would be fine for the transmissive members 7a and 7b to be lenses.

### Fourth Preferred Embodiment

Next, a fourth preferred embodiment of the present invention will be explained.

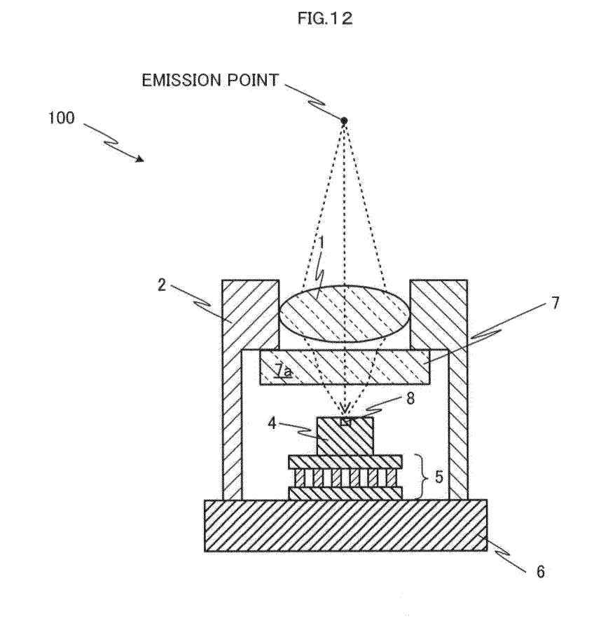

In this preferred embodiment, the optical module 100 will be explained taking an optical transceiver TO-CAN-type as an example. FIG. 12 shows the composition of the optical module 100 according to this preferred embodiment. The optical module 100 has the same composition as the first preferred embodiment with the exception of being provided with a photodiode 8 in place of the semiconductor laser 3. Below, primarily the points of difference from the first preferred embodiment are explained.

An output end of an optical fiber, for example, is positioned at the position corresponding to the emission point. Light emitted from the output end (emission point) of the optical fiber is focused by the lens 1 and is guided to the photodiode 8.

The photodiode 8 is positioned at a position corresponding to the focal point and receives light emitted from the emission point. The photodiode 8 is controlled by the temperature of the Peltier device 5. By doing this, the effects of changes in the temperature of the optical module 100 corresponding to the properties of the photodiode 8 are reduced.

Thermal expansion of the lens cap 2 and control of position shifting of the focal point in this preferred embodiment will be explained. The length of the lens cap 2 becomes longer in the direction of the optical axis of the lens 1 due to heat generation by the optical module 100. Consequently, the relative distance between the lens 1 and the photodiode 8 becomes longer. As a result, position shifting occurs between the photodiode 8 and the focal point.

Because of being in contact with the lens cap 2, the transmissive member 7a thermally expands in the direction of the optical axis of the lens 1 in accordance with the rising temperature of the lens cap 2. When the thickness of the transmissive member 7a increases due to thermal expansion, it is possible to cause the position of the focal point to shift in a direction separating from the lens 1 the same as in FIG. 10 explained in the above-described second preferred embodiment. Consequently, it is possible to reduce position shifting between the photodiode 8 and the focal point. As a result, it is possible to reduce tracking errors caused by position shifting of the focal point of light relating to the optical axis direction.

As explained in detail above, with the optical module 100 according to this preferred embodiment, even when the optical module 100 receives light, it is possible to reduce tracking errors caused by position shifting of the focal point of light related to the optical axis direction, the same as in the first preferred embodiment.

It would be fine for the optical module 100 according to this preferred embodiment to be provided with at least one out of the transmissive member 7b in the above-described second preferred embodiment or the control member 7c in the third preferred embodiment. In this case, the transmissive member 7b is positioned on the opposite side as the transmissive member 7a so that the lens 1 is interposed in between. In addition, the control member 7c is inserted between the stem 6 and the photodiode 8. By doing this, it is possible to further reduce tracking errors caused by position shifting of the focal point of light related to the optical axis direction.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.
1 Lens
2 Lens cap
3 Semiconductor laser
4 Carrier
5 Peltier device
5a Top layer
5b Bottom layer
6 Stem
7, 7c Control member
7a, 7b Transmissive member
8 Photodiode
100 Optical module

What is claimed is:

1. An optical module comprising:
an optical device for focusing at a focal point light emitted from an emission point;
a support body provided on a substrate for supporting the optical device; and
a control member for controlling position shifting of the focal point generated by thermal expansion of the support body, through thermal expansion in the direction of the optical axis of the optical device.

2. The optical module according to claim 1, wherein the control member:
is installed on the optical path between the emission point and the focal point; and
is a transmissive member having a refractivity n exceeding the refractivity of the atmosphere.

3. The optical module according to claim 2, wherein the linear thermal expansion coefficient of the transmissive member is greater than 1/(1−1/n) times the linear thermal expansion coefficient of the support body.

4. The optical module according to claim 2, wherein transmissive members are respectively positioned on both sides of the optical device in the optical axis direction.

5. The optical module according to claim 2, wherein the transmissive member is a parallel slab or a lens.

6. The optical module according to claim 2, wherein the transmissive member is made of plastic.

7. The optical module according to claim 2, wherein the transmissive member:
is in a shape with rotational symmetry about the optical axis;
is fixed to the support body at a fringe on the surface attached to the support body; and
has a linear thermal expansion coefficient greater than the linear thermal expansion coefficient of the support body.

8. The optical module according to claim 7, wherein the optical axis of the transmissive member matches the optical axis of the optical device.

9. The optical module according to claim 7, wherein the optical axis of the transmissive member is shifted from the optical axis of the optical device.

10. The optical module according to claim 2, wherein the transmissive member is such that the length in a first direction orthogonal to the direction of the optical axis of the optical device is different from the length in a second direction orthogonal to the optical axis and the first direction.

11. A light transmission method for an optical module comprising:
an optical device for focusing at a focal point light emitted from an emission point; and
a support body provided on a substrate, for supporting the optical device;
wherein this light transmission method controls position shifting of the focal point generated by thermal expansion of the support body, through thermal expansion in the direction of the optical axis of the optical device.
